(19) United States
(12) Patent Application Publication
(10) Pub. No.: US 2025/0314345 A1
(43) Pub. Date: Oct. 9, 2025

(54) DETACHABLE STRUCTURE AND AUXILIARY SHOOTING DEVICE

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/091,718

(22) Filed: Mar. 26, 2025

(30) Foreign Application Priority Data
Apr. 8, 2024 (CN) 202420742399X
Jun. 13, 2024 (CN) 2024213589085

(51) Int. Cl. F16M 11/16; F16M 11/20; G03B 17/56

(52) U.S. Cl. CPC F16M 11/16; F16M 11/20; G03B 17/561; F16M 2200/027

(57) ABSTRACT

The present disclosure presents a detachable structure and an auxiliary shooting device, pertaining to the realm of shooting auxiliary equipment. The device encompasses a base featuring a clamping part; a clamping member movably positioned on the base, opposing the clamping part to form a clamping groove for securing a quick-release plate, wherein the quick-release plate can depress the clamping member to cause flipping; an unlocking assembly movably positioned within the base, being able to propel the clamping member back to the original position, thereby releasing the quick-release plate from the clamping groove; and a locking assembly movably positioned on the base, being able to counteract the unlocking assembly to drive the clamping member and the clamping part to grip the quick-release plate within the clamping groove.

### CROSS-REFERENCE TO RELATED APPLICATIONS

The present application for patent claims priority to and the benefit of pending Chinese Application No. 202420742399X and No. 2024213589085, filed Apr. 8, 2024 and filed Jun. 13, 2024 respectively, and hereby expressly incorporated by reference herein as if fully set forth below in its entirety and for all applicable purposes.

### TECHNICAL FIELD

The present disclosure pertains to the field of shooting auxiliary equipment, specifically addressing a detachable structure and an auxiliary shooting device.

### INTRODUCTION

In photography, to aid photographers in achieving desired photographic effects, tripods are frequently utilized as shooting aids. A typical tripod structure includes a tripod body, a quick-release plate, and a camera assembly. The camera assembly can be a standalone camera or a camera equipped with various additional accessories, such as a camera with a full cage. This camera assembly detachably attaches to the tripod body via the quick-release plate, which allows for removal of both the plate and the assembly from the tripod body together.

However, currently available quick-release plates are commonly installed on the tripod body using a double-bevel mating structure akin to a dovetail groove. This design only permits the quick-release plate to slide back and forth relative to the tripod body for removal, prohibiting direct removal without directional constraints, thus hindering the convenient installation and removal of the camera assembly.

### BRIEF SUMMARY

The present disclosures provide a detachable structure and an auxiliary shooting device that enhance the ease of installing and removing the camera assembly.

The present disclosure is as follows:

The present disclosure introduces a detachable structure including:
a base featuring a clamping part;
a clamping member, movably positioned on the base, opposing the clamping part to form a clamping groove for securing a quick-release plate; the quick-release plate can depress the clamping member to cause flipping or pivoting, causing the clamping member and clamping part to clamp the quick-release plate within the clamping groove;
an unlocking assembly, movably positioned within the base, being able to propel the clamping member back to an original position, thereby releasing the quick-release plate from the clamping groove;
a locking assembly, movably positioned on the base, being able to counteract the unlocking assembly to drive the clamping member and the clamping part to grip the quick-release plate within the clamping groove.

### BRIEF DESCRIPTION OF THE DRAWINGS

FIG. 1 is a diagram illustrating an auxiliary shooting device according to some aspects of the disclosure.

FIG. 2 is a diagram illustrating a detachable structure according to some aspects of the disclosure.

FIG. 3 is a diagram illustrating an exploded view of the detachable structure of FIG. 2.

FIG. 4 is a diagram illustrating a base according to some aspects of the disclosure.

FIG. 5 is a diagram illustrating an assembly of a clamping member, a unlocking assembly, and a locking assembly according to some aspects of the disclosure.

FIG. 6 is a diagram illustrating a clamping member according to some aspects of the disclosure.

FIG. 7 is a diagram illustrating a unlocking member according to some aspects of the disclosure.

FIG. 8 is a diagram illustrating a dissembled state of a locking wrench, a limiting switch, and a torsion spring according to some aspects of the disclosure.

FIG. 9 is a diagram illustrating a detachable structure employing a safety latch mechanism for the locking wrench according to some aspects of the disclosure.

FIG. 10 is a diagram illustrating a partial view in FIG. 3.

FIG. 11 is a diagram illustrating a sectional view of the detachable structure according to some aspects of the disclosure.

### REFERENCE NUMBERS

100. detachable structure, 200. tripod body.
1. base, 11. clamping part, 12. holding groove, 13. mounting groove, 14. sliding groove,
2. clamping member, 21. limiting protrusion, 22. bottom arm, 23. upper arm, 3. clamping groove, 4. quick-release plate, 5. unlocking assembly, 51. unlocking member, 52. driving member, 53. clamping reset elastic element, 55, driving reset spring, 511. limiting groove, 512. abutment surface, 513. top block, 54. unlocking reset spring, 6. moving groove.
7. locking assembly, 71. middle part, 72. locking wrench, 721. pressing part, 722. eccentric groove, 723. shifting position, 73. fixed shaft, 731. shaft hole, 74. connecting rod, 75. washer, 76. limiting switch, 761. abutment protrusion, 77. torsion spring, 78. detent tooth, 79. sliding latch, 791. blocking wall, 710. blocking position.

### DETAILED DESCRIPTION

To clarify the objectives, technical solutions, and aspects of this disclosure, further detailed descriptions are provided below in conjunction with the accompanying drawings and embodiments. It should be noted that the specific embodiments presented herein are solely for the purpose of illustrating this disclosure and are not intended to restrict its scope.

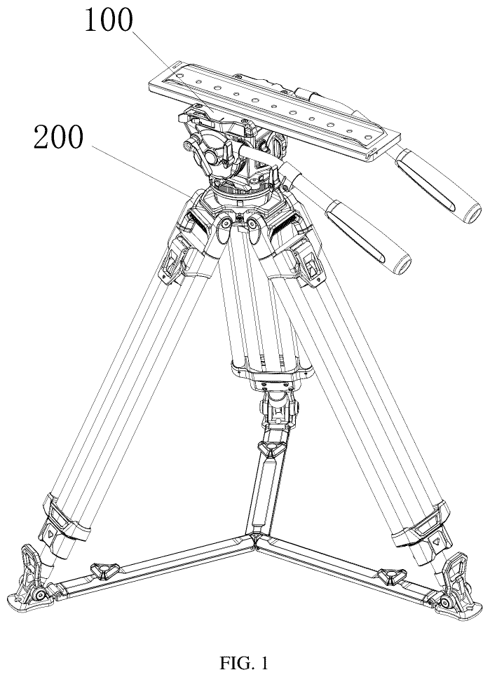

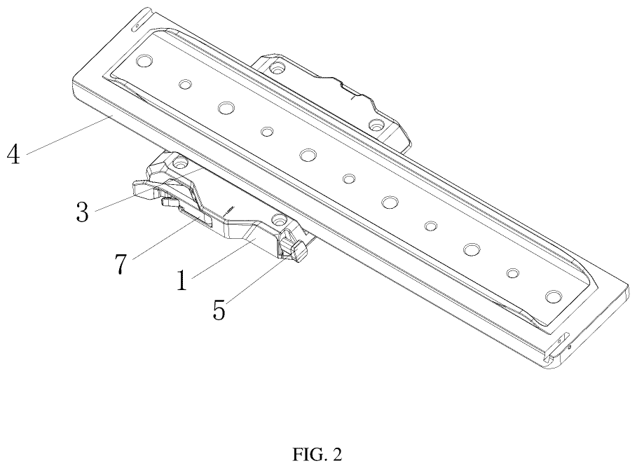

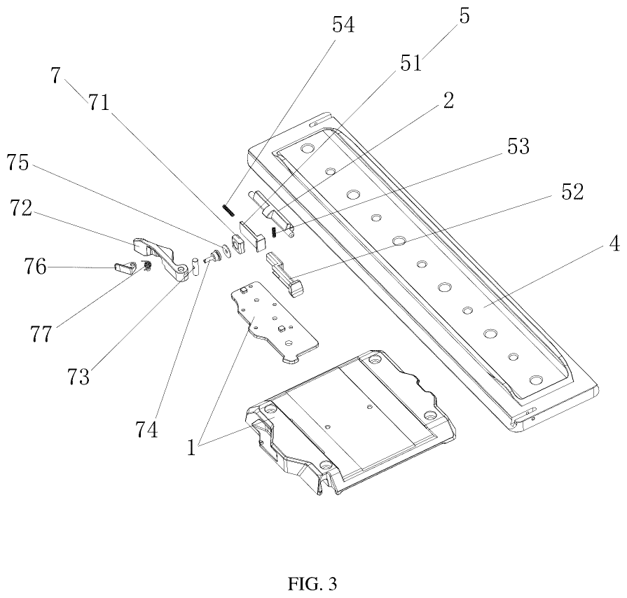

Referring to FIGS. 1-11, a detachable structure 100, includes:
a base 1 with a clamping part 11 (e.g., a clamping portion);
a clamping member 2 (e.g., a clamping element) movably disposed on the base 1, facing the clamping part 11 to form a clamping groove 3 for securing the quick-release plate 4 in the clamping groove 3. The quick-release plate 4 can press the clamping member 2, causing the clamping member 2 to flip or pivot;
an unlocking assembly 5 movably disposed within the base 1, configured to drive the clamping member 2 to reset, thereby releasing the quick-release plate 4 from the clamping groove 3;
a locking assembly 7 movably mounted on the base 1, triggering the clamping member 2 and clamping part 11 to clamp the quick-release plate 4 within the clamping groove 3.

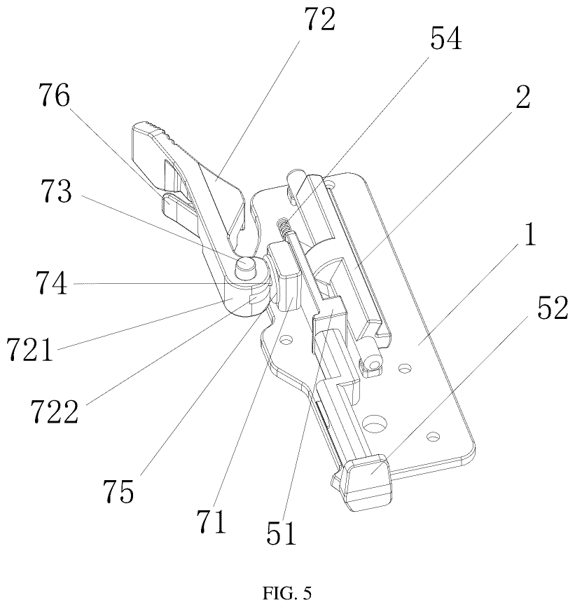

In some aspects, the clamping groove 3 (e.g., a slot or a channel) can be adjusted in size (e.g., expanded or contracted) via the movement of the clamping member 2. When the quick-release plate 4 is positioned in the clamping groove 3 and presses the clamping member 2 causing it to flip or pivot, the clamping groove 3 contracts. Subsequently, by rotating the locking assembly 7, the quick-release plate 4 can be securely clamped in the clamping groove 3 between the clamping member 2 and the clamping part 11. Conversely, rotating the locking assembly 7 in the opposite direction and triggering the unlocking assembly 5 expands the clamping groove 3, enabling the release of the quick-release plate 4. Additionally, after expanding the clamping groove 3, the quick-release plate 4 can be removed from both the front and rear ends of the clamping groove 3, as well as from above, without directional restrictions, facilitating more convenient and effortless installation and removal. It is noteworthy that, as illustrated in FIG. 5, in this embodiment, the locking assembly 7 is positioned opposite the clamping member 2 relative to the unlocking assembly 5. Rotating the locking assembly 7 abuts the unlocking assembly 5, further driving the clamping member 2 towards the quick-release plate 4, thereby clamping the quick-release plate 4 securely in the clamping groove 3.

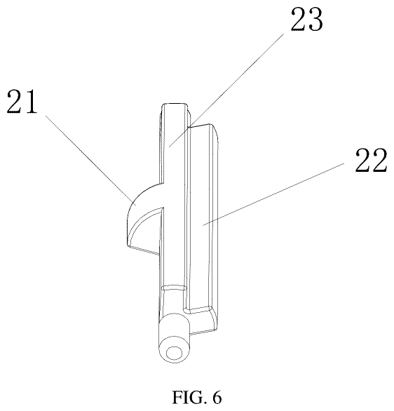

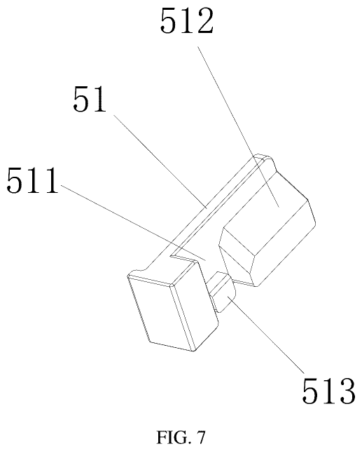

In some aspects, the unlocking assembly 5 includes an unlocking member 51 (e.g, unlocking piece) and a driving member 52 (e.g, driving piece). The driving member 52 is movably disposed within the base 1, with one end exposed externally. A limiting protrusion 21 (see FIG. 6) is provided on the clamping member 2. The unlocking member 51 is movably connected to the base 1 and is resiliently biased, for example, by a spring. The unlocking member 51 features a limiting groove 511 and an abutment surface 512 (see FIG. 7). The driving member 52 can activate the unlocking member 51, enabling the limiting groove 511 or abutment surface 512 to cooperate with the limiting protrusion 21 to place the clamping member 2 in a locked or unlocked state, or to switch between the two states. In this embodiment, when the limiting protrusion 21 is within the limiting groove 511, the clamping member 2 can transition to the unlocked state, enabling the installation of the quick-release plate 4 into the clamping groove 3. The quick-release plate 4 presses and flips (e.g, pivots) the clamping member 2, causing the clamping groove 3 to contract, and the limiting protrusion 21 follows the clamping member 2 in a counterclockwise flip. Subsequently, the unlocking member 51 resets, transitioning the limiting protrusion 21 to a state of abutment against the abutment surface 512. At this point, the locking assembly 7 is configured to press against the unlocking member 51 and the clamping member 2 when a user rotates the locking assembly 7 in a direction towards the clamping groove 3. For example, when a user places the quick-release plate 4 into the clamping groove 3, the quick-release plate 4 depresses the clamping member, causing the clamping member to pivot. At this time, the quick-release plate 4 is not able to disengage from the clamping groove 3, but can slide along the clamping groove 3. Then, the user can rotate the locking assembly 7 in the direction towards the clamping groove 3 so that the locking assembly 7 presses against unlocking member 51.

In some aspects, a top block 513 (see FIG. 7) can be provided within the limiting groove 511. When the limiting protrusion 21 flips into the limiting groove 511, the top block 513 provides abutment or a stop. The top block 513 supports the limiting protrusion 21 from below, preventing excessive flipping (or rotation) and potential dislodgment from the limiting groove 511.

In some aspects, the unlocking assembly 5 encompasses an unlocking reset spring 54 (sec FIG. 5) and a driving reset spring 55 (see FIG. 11). One end of the unlocking reset spring 54 interfaces with the unlocking member 51, while the other end interfaces with the inner wall of the base 1. Similarly, one end of the driving reset spring 55 interfaces with the driving member 52, and the opposite end interfaces with the inner wall of the base 1. The expansion and contraction directions of both the unlocking reset spring 54 and the driving reset spring 55 are perpendicular to the flipping (or rotation) direction of the clamping member 2. In some aspects, activating the driving member 52, along with the unlocking member 51, compresses the unlocking reset spring 54 and the driving reset spring 55. Upon releasing the pressing force, the deformation and elongation of the unlocking reset spring 54 and the driving reset spring 55 facilitate the reset of both the unlocking member 51 and the driving member 52. The unlocking reset spring 54 and the driving reset spring 55, when compressed, propel the unlocking member 51 and the driving member 52 vertically relative to the clamping member 2, allowing the limiting groove 511 and the abutment surface 512 to switch positions relative to the clamping member. This enables the limiting protrusion 21 to switch abutting positions for clockwise and counterclockwise flipping, adjusting the width of the clamping groove 3 and facilitating rapid installation and removal of the quick-release plate 4. Notably, in this embodiment, the driving reset spring 55 allows the driving member 52 to be released once the limiting protrusion 21 engages the limiting groove 511. Subsequently, the driving member 52 resets under the action of the driving reset spring 55, while the limiting groove 511 retains the limiting protrusion 21. Thus, during installation, the user need not continuously press the driving member 52.

In some aspects, the clamping member 2 includes a bottom arm 22 and an upper arm 23, interconnected to form a “V”-shaped pressing position. The clamping part 11 abuts against one side of the quick-release plate 4, while the opposite side of the quick-release plate 4 is pressed against the pressing position formed by the bottom arm 22 and upper arm 23, enabling the bottom arm 22 and the upper arm 23 to abut against the quick-release plate 4. A clamping reset elastic clement 53, positioned between the bottom arm 22 and the base 1, facilitates the reset of the bottom arm 22. One end of the clamping reset clastic element 53, adjacent to the clamping member 2, interfaces with the bottom of the bottom arm 22, while the limiting protrusion 21 is situated on the side of the upper arm 23 facing away from the clamping groove 3.

In some aspects, to assemble the camera and the tripod base 1, pressing the driving member 52 aligns the limiting groove 511 with the limiting protrusion 21. The clamping reset elastic element 53 then propels the clamping member 2 to flip counterclockwise, engaging the limiting protrusion 21 in the limiting groove 511 and widening the clamping groove 3. This allows the quick-release plate 4 to be smoothly inserted into the clamping groove 3. Upon insertion, the quick-release plate 4 presses the clamping member 2 to flip clockwise, disengaging the limiting protrusion 21 from the limiting groove 511 and compressing the clamping reset elastic element 53. The quick-release plate 4 is then locked in the clamping groove 3, completing the assembly of the quick-release plate 4 and the base 1. At this stage, the unlocking member 51 resets, positioning the abutment surface 512 against the limiting protrusion 21. For disassembly, rotate the locking assembly 7 in the opposite direction (unlock direction), then press the driving member 52 to move the unlocking member 51, aligning the limiting groove 511 with the limiting protrusion 21. The clamping member 2 flips counterclockwise due to the clamping reset clastic element 53, engaging the limiting protrusion and widening the clamping groove 3, thus releasing the quick-release plate 4 for removal from above or front to back direction relative to the base 1, with no directional constraint. When the clamping groove 3 is empty, the bottom arm 22 of the clamping member 2 rises under the support of the clamping reset elastic element 53, while the upper arm 23 moves away from the clamping groove 3, facilitating the insertion of the quick-release plate 4 into the clamping groove 3. Upon insertion, the bottom of the quick-release plate 4 presses the bottom arm 22, causing the clamping member 2 to flip clockwise. The upper arm 23 rotates towards the clamping groove 3, clamping the edge of the quick-release plate 4 with the pressing position, and subsequently locking the quick-release plate 4 via the locking assembly 7.

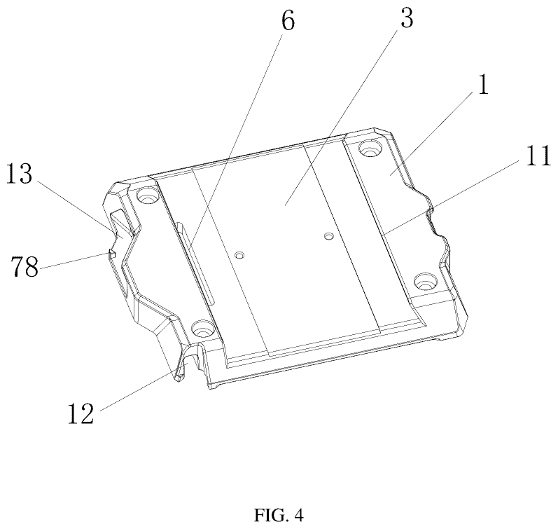

In some aspects, a moving groove 6 (see FIG. 4) can be incorporated on the side wall of the clamping groove 3 opposite the clamping part 11, allowing the clamping member 2 to move within moving groove 6. A holding groove 12, communicating with the moving groove 6, can also be incorporated in the base 1. The unlocking member 51, the driving member 52, the clamping reset elastic element 53, the unlocking reset spring 54, and the driving reset spring 55 are all movably disposed within the holding groove 12.

In some aspects, the base 1 can feature a locking assembly 7. This locking assembly 7 incorporates a locking wrench 72 rotatably attached to the base 1. The locking wrench 72 includes an eccentric pressing part 721 (e.g., pressing portion, eccentric cam), with a fixed shaft 73 penetrating through the pressing part 721. The fixed shaft 73 is rotatably connected to the pressing part 721, and both ends of the fixed shaft 73 are securely fastened to the base 1. A side of the unlocking member 51, facing away from the clamping member 2, abuts against the pressing part 721. In some aspects, as illustrated in FIG. 5, when a gap exists between the quick-release plate 4 and the base 1, rotating the locking wrench 72 utilizes the eccentric pressing part 721 to abut against the unlocking member 51, subsequently compressing tightly against the clamping member 2. This action forces the clamping member 2 towards the quick-release plate 4, eliminating the clearance between the quick-release plate 4 and the base 1 and enhancing the stability of the detachable structure 100. Conversely, rotating the locking wrench 72 in the opposite direction (release direction) releases the pressure, allowing the middle part 71 (e.g, middle portion) to loosen, eliminating the pressure on the unlocking member 51, facilitating the insertion of the quick-release plate 4 into the clamping groove 3.

In some aspects, the locking assembly 7 includes a middle part 71 and a connecting rod 74. The middle part 71 is positioned between the unlocking member 51 and the pressing part 721. One end of the connecting rod 74 is movably connected to the fixed shaft 73, while the other end connects to the middle part 71. A first groove 722 within the pressing part 721 avoids the connecting rod 74. In some aspects, the connecting rod 74 serves as a bridge between the fixed shaft 73 and the middle part 71. When rotating, the locking wrench 72 propels the middle part 71. Since the connecting rod 74 is inserted into the pressing part 721 and connected to the fixed shaft 73, the first groove 722 ensures that the connecting rod 74 does not hinder the rotation of the locking wrench 72.

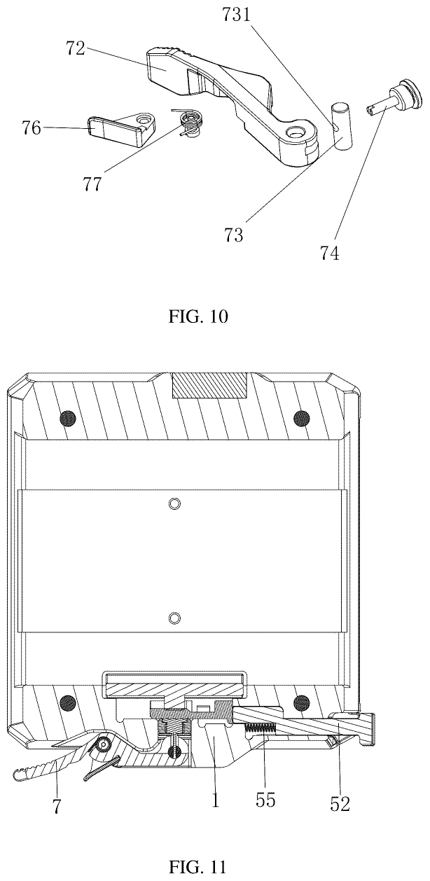

Moreover, a shaft hole 731 aligned with the movement path of the connecting rod 74 is incorporated within the fixed shaft 73. One end of the connecting rod 74 is securely attached to the middle part 71, while the other end is movably positioned within the shaft hole 731 (see FIG. 10). As the connecting rod 74 and middle part 71 move, the end of the connecting rod 74 remains within the shaft hole 731, providing guidance and constraint.

Furthermore, a washer 75, can be situated between the middle part 71 and the pressing part 721, allowing the connecting rod 74 to pass through. The washer 75 reduces wear between the locking wrench 72/pressing part 721 and the middle part 71.

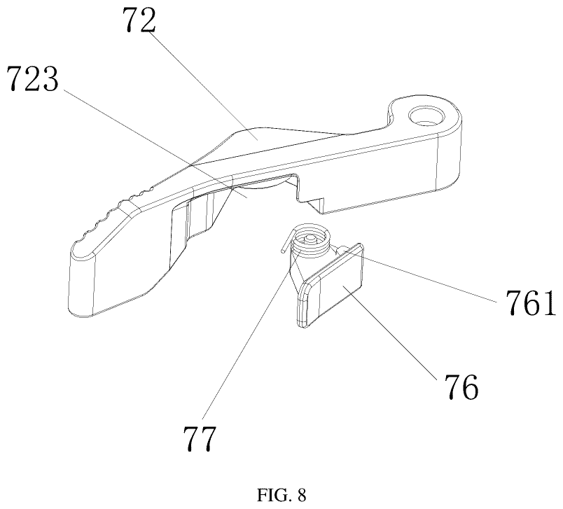

Furthermore, the base 1 can feature a mounting groove 13 (see FIG. 4) where the locking wrench 72 is movably installed. The locking assembly 7 can include a limiting switch 76 and a torsion spring 77 (see FIG. 8). A shifting position 723 (e.g, a cavity) on the locking wrench 72 houses both the torsion spring 77 and the limiting switch 76. The limiting switch 76 is rotatably connected to the locking wrench 72. One end of the torsion spring 77 abuts against the locking wrench 72, while the other end engages with the limiting switch 76. A detent tooth 78 (see FIG. 4) can be situated at the shifting position 723, fixed to the inner wall of the mounting groove 13, and can restrict the movement of the limiting switch 76. For example, the torsion spring 77 is extended, and the limiting switch 76 abuts against the detent tooth 78, preventing the locking wrench 72 from moving within the mounting groove 13 and inadvertently rotating, which can compromise the lock. To rotate the locking wrench 72, the limiting switch 76 is pressed away from the detent tooth 78, disengaging the limiting switch 76 from the detent tooth 78 and allowing the locking wrench 72 to move within a specific range for locking.

In some aspects, an abutment protrusion 761 is set on the limiting switch 76. The end of the torsion spring 77, near the limiting switch 76, abuts against the abutment protrusion 761.

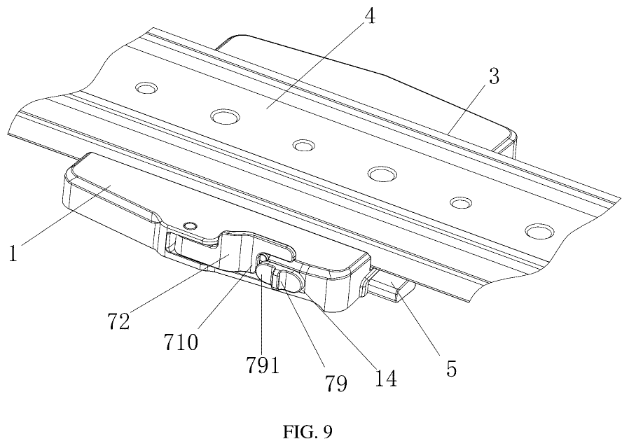

As shown in FIG. 9, to prevent accidental engagement of the locking wrench 72, another embodiment can include a sliding groove 14 on the side of the mounting groove 13, housing a slidable sliding latch 79. A blocking wall 791 on the sliding latch 79 corresponds to a blocking position 710 on the outer side of the locking wrench 72. The blocking wall 791 slides into and out of the blocking position 710. In some aspects, when the sliding latch slide into the blocking position 710, the blocking wall 791 restricts the movement of the locking wrench 72 within the mounting groove 13, preventing accidental rotation and unlocking. Conversely, when the blocking wall 791 slides out of the blocking position 710, the locking wrench 72 can move relative to the mounting groove 13 for locking or unlocking.

As shown in FIG. 1, an auxiliary shooting device can utilize the aforementioned detachable structure 100 and a tripod body 200. The base 1 of the detachable structure 100 attaches to the tripod body 200, while the quick-release plate 4 facilitates the installation of camera accessories. The detachable structure 100 facilitates rapid attachment and detachment of camera accessories relative to the tripod body 200.

The above description outlines exemplary embodiments of the present disclosure and is not intended to limit its scope. Any modifications, equivalent substitutions, and improvements made within the spirit and principles of this disclosure should be considered within the scope of its protection.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A detachable structure, comprising:
a base comprising a clamping part;
a clamping member movably provided on the base, opposing the clamping part to form a clamping groove configured to retain a quick-release plate, wherein the quick-release plate is configured to depress the clamping member, causing the clamping member to pivot;
an unlocking assembly movably provided in the base, wherein the unlocking assembly is configured to reset the clamping member, thereby releasing the quick-release plate from the clamping groove; and
a locking assembly, movably positioned on the base and abutting against the unlocking assembly, wherein the locking assembly is configured to drive the clamping member to lock the quick-release plate within the clamping groove.

2. The detachable structure according to claim 1, wherein the unlocking assembly comprises an unlocking member and a driving member;
wherein the driving member is movably installed on the base and a portion of the driving member is exposed outside the base;
wherein the clamping member comprises a limiting protrusion, and the unlocking member is elastically and movably connected to the base and provided with a limiting groove and an abutment surface; and
in response to an actuation of the driving member, the unlocking member is configured to move the unlocking member relative to the limiting protrusion, enabling the clamping member to transition between a locked state corresponding to the limiting groove and an unlocked state corresponding to the abutment surface.

3. The detachable structure according to claim 2, wherein a top block is disposed within the limiting groove; and
wherein the top block abuts against the bottom of the limiting protrusion when the limiting protrusion moves into the limiting groove.

4. The detachable structure according to claim 2, wherein the clamping member comprises a bottom arm and an upper arm, and a pressing position is provided between the upper arm and the bottom arm;
wherein the limiting protrusion is located on a side of the upper arm facing away from the clamping groove;
wherein a clamping reset elastic element is disposed between the bottom arm and the base to reset the bottom arm;
wherein the bottom arm and the upper arm are configured to pivot and abut against the quick-release plate when the clamping part abuts against one side of the quick-release plate, and an opposite side of the quick-release plate is configured to press against the pressing position; and
wherein the clamping reset elastic element is configured to drive to the bottom arm and the upper arm for releasing the quick-release plate in response to unlocking the locking assembly and actuating the driving member.

5. The detachable structure according to claim 2, wherein a moving groove is disposed on a side of the clamping groove opposite to the clamping part, and the clamping member is movably installed in the moving groove;
wherein a holding groove communicating with the moving groove is disposed within the base; and
wherein both the unlocking member and the driving member are movably positioned within the holding groove.

6. The detachable structure according to claim 2, wherein the locking assembly comprises a locking wrench rotatably connected to the base; and
wherein the locking wrench comprises an eccentric pressing part, which rotatably connects to the base via a fixed shaft that traverses through the eccentric pressing part, and the eccentric pressing part is configured to abut against the unlocking member.

7. The detachable structure according to claim 6, wherein the locking assembly further comprises a middle part and a connecting rod;
wherein the middle part is positioned between the unlocking member and the eccentric pressing part;
wherein a first end of the connecting rod is movably connected to the fixed shaft, while a second end of the connecting rod is connected to the middle part; and
wherein a first groove, configured to avoid the connecting rod, is provided within the eccentric pressing part.

8. The detachable structure according to claim 7, wherein a shaft hole, aligned with a moving direction of the connecting rod, is disposed within the fixed shaft; and
wherein a first end of the connecting rod is securely connected to the middle part, while a second end of the connecting rod away from the middle part is movably positioned within the shaft hole.

9. The detachable structure according to claim 6, wherein a mounting groove is disposed on the base, and the locking wrench is movably installed within the mounting groove;
wherein the locking assembly further comprises a limiting switch and a torsion spring;
wherein a shifting position is provided on the locking wrench, and both the torsion spring and the limiting switch are positioned within the shifting position;
wherein the limiting switch is rotatably attached to the locking wrench;
wherein a first end of the torsion spring abuts against the locking wrench, and a second end of the torsion spring abuts against the limiting switch; and
wherein a detent tooth configured to impede the limiting switch from movement, is provided on the shifting position and securely connected to an inner wall of the mounting groove.

10. The detachable structure according to claim 9, wherein an abutment protrusion is disposed on the limiting switch, with one end of the torsion spring facing the limiting switch abutting against the abutment protrusion.

11. The detachable structure according to claim 6, wherein a mounting groove is disposed on the base, with the locking wrench movably installed within the mounting groove;
wherein a sliding groove is disposed on one side of the mounting groove, and a sliding latch, slidably positioned within the sliding groove, is equipped with a blocking wall; and
wherein an outer side of the locking wrench forms a blocking position, and the blocking wall sliding in and out of the blocking position.

12. An auxiliary shooting device utilizing the detachable structure according to claim 1, comprising a tripod body, and the base is mounted on the tripod body.
